(19) United States
(12) Patent Application Publication
(10) Pub. No.: US 2019/0392099 A1
(43) Pub. Date: Dec. 26, 2019

(54) METHOD AND APPARATUS FOR MODELING ELECTROMAGNETIC FIELDS USING HERMITE FINITE ELEMENTS

(71) Applicant: WORCESTER POLYTECHNIC INSTITUTE, Worcester, MA (US)

(72) Inventors: Siddhant Pandey, Worcester, MA (US); Sathwik Bharadwaj Daralagodu Dattatreya Jois, Worcester, MA (US); Lakshminarayanapuram Ramdas Ram-Mohan, Westborough, MA (US)

(73) Assignee: Worcester Polytechnic Institute, Worcester, MA (US)

(21) Appl. No.: 16/451,612

(22) Filed: Jun. 25, 2019

Related U.S. Application Data
(60) Provisional application No. 62/689,307, filed on Jun. 25, 2018.

(51) Int. Cl. G06F 17/50

(52) U.S. Cl. CPC G06F 17/5018; G06F 2217/16

(57) ABSTRACT

Embodiments of the innovation relate to, in a modeling apparatus, a method of identifying electromagnetic behavior of an electronic component. The method includes receiving, by the modeling apparatus, geometric design criteria and material property criteria for the component; defining, by the modeling apparatus, a set of finite elements representing the component based upon the geometric design criteria and material property criteria; applying, by the modeling apparatus, a Hermite finite element method function to each finite element to define an electromagnetic field for each finite element; applying, by the modeling apparatus, a divergence-free condition at each node of each finite element to define an electromagnetic field at each node; and based upon application of the Hermite finite element method function and the divergence free condition to generate the electromagnetic fields, generating, by the modeling apparatus, a model of the electromagnetic behavior of the component.

### RELATED APPLICATIONS

This patent application claims the benefit of U.S. Provisional Application No. 62/689,307, filed on Jun. 25, 2018, entitled, “Method and Apparatus for Modeling Electromagnetic Behavior Using Hermite Finite Elements,” the contents and teachings of which are hereby incorporated by reference in their entirety.

### BACKGROUND

In multi-scale and multi-physics device development involving electromagnetic fields, the design and prototyping process can be costly and time consuming. To mitigate costs, computerized devices can be utilized during the design process to simulate the operation of the electronic device prior to the construction of a physical prototype. For example, conventional computerized devices can be configured to utilize mathematical models to represent or approximate the electronic device, such as an electronic package or a multi-layer printed circuit board (PCB), and can simulate the response of the device during operation.

With the ongoing development of integrated circuit technology, under the principle of Moore's law, the number of transistors in an integrated circuit will increase over time. Further, with certain electronic devices, such as antennae or integrated circuits, the presence of electromagnetic fields generated by the device can affect device operation. For example, the increase in the number of transistors can affect the presence of electromagnetic fields and can increase unwanted crosstalk. The crosstalk, in turn, can interfere with integrated circuit signal propagation. Therefore, in order to identify and mitigate the potential effects of the electromagnetic fields on electronic devices, such as integrated circuits, before physical prototypes are constructed, device designers can also utilize computerized devices to simulate the presence of the electromagnetic fields within the electronic devices.

One typical approach for simulating electromagnetic fields is through the use of the Vector Finite Element Method (VFEM). VFEM can provide variational electromagnetic field modeling by discretizing the physical geometry of the electronic device. Such a discretizing process is utilized to overcome geometrical complications found in many conventional electronic devices.

### SUMMARY

As provided above, the presence of electromagnetic fields in certain electronic devices can adversely affect the devices' operation. As such, in order to accurately design devices, such as antennae, optical fibers, quantum well lasers in resonant cavities, high frequency integrated circuits, electron microscopes, and vacuum tubes, designers typically need reliable and accurate electromagnetic field simulation during the design process. While VFEM is typically utilized to simulate electromagnetic fields within electronic devices, VFEM suffers from a variety of deficiencies.

In the conventional finite element method (FEM), a computerized device can discretize a physical region of an electronic device into triangles and squares in 2D and into tetrahedral and cubes in 3D. The conventional representation of electromagnetic fields in each of these finite elements is in terms of edge-based interpolation or mixed-order polynomials.

The disadvantage of mixed-order polynomial approaches is the inherent imbalance in discretization error with increasing mesh density. While every discretization method introduces errors with arbitrary mesh scaling, h-convergence is achieved in a well behaved finite element calculation, and it would be expected that increasing the mesh density where solutions change rapidly should provide much better real space functions until extremely dense conditions prevail.

In mixed-order elements, mesh refinement toward a dense grid can decrease the overall quality of the field representation in polynomials. For example, because field components with projections normal to the triangle boundaries occur ubiquitously, the increasing portions of real space are described by lower order polynomials. In the limit of a very dense mesh, the entire solution can be no better than the lowest order description because the inter-element boundary regions dominate over the vanishing interior.

Further, electromagnetic field representations in VFEM are typically undefined at the mesh nodes. For example, FIG. 1 illustrates a VFEM-generated element 10 having several triangles 12 formed relative to a corner node or vertex 14. However, conventional VFEM basis functions can produce ambiguous vector fields 16 at triangle vertices 14. As indicated in FIG. 1, when approaching a point in space that is shared as a common corner node 14 of several triangles 12, this node 14 produces fields 16 that are unique to each triangle 12. Since there is no continuity among the triangles 12, this creates an overdetermined basis representation for the fields 16 at the vertices 12. The overdetermined basis occurs because the basis decomposes the field 16 at the vertices 14 as projections orthogonal to adjacent edges that are not shared among all the triangles 12 sharing the node 14. Therefore, unless additional numerical techniques are deployed to mitigate the presence of multiple definitions of the vector field 16 at shared vertices 14, a relatively dense mesh results in, at best, a constant value description. In addition, when such fields 16 calculated using VFEM are employed in further applications, such as determination of electron trajectories in accelerators or in high power vacuum tube design, these regions can inject uncertainties in the charged particle trajectories around the vertices 14.

Given the inherent side effects of vector basis element discretization, conventional VFEM solution enhancement and refinement has focused on the construction of higher order polynomial basis functions to increase spatial resolution, rather than dense meshing (e.g., p-convergence). These hierarchical approaches to better spatial resolution has resulted in mesh refinement or the discretization of disparately sized physical regions which can require the mating of finite elements with different basis orders.

VFEM is also ineffective in modeling multi-physics problems which involve quantum mechanical or acoustic, and electrodynamic aspects in tandem, such as designing cavity lasers. In such instances, independent numerical treatments are needed to obtain wave functions and electromagnetic (EM) fields.

Further, the use of conventional VFEM is a computationally expensive procedure. For example, software packages such as COMSOL (produced by COMSOL Inc.), HFSS (produced by ANSYS, Inc.), and MFEM (produced by CASC, LLNL) are configured to model the null-frequency space (k₀=ω/c=0) of the electronic device, and then iteratively eliminate these null-frequency spaces from the total spectrum. This iterative process is relatively time consuming.

By contrast to conventional approaches, embodiments of the present innovation relate to a method and apparatus for modeling electromagnetic behavior using Hermite finite elements. In one arrangement, a modeling apparatus is configured to utilize a Hermite finite element method function to represent an electromagnetic field of each element of an electronic component under development. With the use of Hermite finite element method function, the modeling apparatus can resolve the above-described issues arising with VFEM in both two- and three-dimensions. For example, with use of the Hermite finite element method function, the modeling device can obtain high spatial resolution of the electromagnetic field while mitigating the effects of computational scaling and discretization errors. Further, use of the Hermite finite element method function improves the operation of the modeling apparatus relative to conventional computerized devices by reducing the amount of time necessary to generate a model of an electromagnetic field.

In one arrangement, the modeling apparatus is configured to utilize scalar Hermite finite element method (HFEM) functions, which employ polynomials that correspond to the function and derivative values (i. e. the degrees of freedom) at each node of a set of 2D and/or 3D finite elements representing the electronic component. The modeling device is configured to employ the Hermite finite element method function with at-least first derivative degrees of freedom. The device space can be discretized using any straight edge elements, such as cubes or tetrahedra. With such a configuration, the modeling apparatus provides better accuracy and smoother representation of the electromagnetic fields in an electronic device relative to those obtained using VFEM. When executing the HFEM function, the modeling device can provide results having several orders of higher accuracy with fewer elements than those needed in conventional 3D implementations of VFEM.

By providing a node-based HFEM representation, the modeling apparatus provides consistency in the direction of fields at the vertices of elements and, hence, is well suited to model transport problems such as electron microscope design and particle accelerators where the particles are driven by microwave fields. Accordingly, the modeling apparatus can provide multiscale calculations with minimal computational costs, which is not feasible with VFEM due to the lack of unique directionality for fields at shared nodes in the finite element mesh.

As will be described below, the modeling apparatus is configured to impose a divergence free condition through a constant Lagrange multiplier term introduced into the action integral, and also by explicitly requiring a zero-divergence condition at each node through the derivative degrees of freedom available at each node. The modeling apparatus can then mitigate or eliminate spurious solutions by identifying them using their large |∇·E|/|∇×E| ratio. This process does not alter or influence the accuracy of the physical solutions.

By utilizing the HFEM function, the modeling apparatus can impose a zero-divergence condition at each node since derivative degrees of freedom exist. While this does not ensure the complete removal of the divergence in the interior of the finite element through interpolation, the modeling apparatus reduces the divergence substantially, particularly as the size of the element is reduced.

Embodiments of the innovation relate to, in a modeling apparatus, a method of identifying electromagnetic behavior of an electronic component. The method includes receiving, by the modeling apparatus, geometric design criteria and material property criteria for the component; defining, by the modeling apparatus, a set of finite elements representing the component based upon the geometric design criteria and material property criteria; applying, by the modeling apparatus, a Hermite finite element method function to each finite element to define an electromagnetic field for each finite element; applying, by the modeling apparatus, a divergence-free condition at each node of each finite element to define an electromagnetic field at each node; and based upon application of the Hermite finite element method function and the divergence free condition to generate the electromagnetic fields, generating, by the modeling apparatus, a model of the electromagnetic behavior of the component.

Embodiments of the innovation relate to modeling apparatus that includes a controller having a processor and a memory. The controller is configured to receive geometric design criteria and material property criteria for the component; define a set of finite elements representing the component based upon the geometric design criteria and material property criteria; apply a Hermite finite element method function to each finite element to define an electromagnetic field for each finite element; apply a divergence-free condition at each node of each finite element to define an electromagnetic field at each node; and based upon application of the Hermite finite element method function and the divergence free condition to generate the electromagnetic fields, generate a model of the electromagnetic behavior of the component.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a prior art corner node of several triangles generated using VFEM.

FIG. 2 illustrates a schematic representation of a modeling system, according to one arrangement.

FIG. 3 is a flowchart showing an example operation of the modeling system of FIG. 2, according to one arrangement.

FIG. 4 illustrates a component configured as a cubic conducting cavity where the cavity is loaded with a concentric cubic dielectric inclusion.

FIG. 5 illustrates a modeling apparatus imposing a divergence-free condition by performing global matrix row and column operations, according to one arrangement.

FIG. 6A illustrates convergence of errors in eigenvalues, according to one arrangement.

FIG. 6B illustrates convergence of errors in eigenvalues, according to one arrangement.

FIG. 7A illustrates modeled surface currents on a component, such as an electronic device in a first of three degenerate modes, according to one arrangement.

FIG. 7B illustrates modeled surface currents on a component, such as an electronic device in a second of three degenerate modes, according to one arrangement.

FIG. 7C illustrates modeled surface currents on a component, such as an electronic device in a third of three degenerate modes, according to one arrangement.

FIG. 8 illustrates a schematic diagram for a vertical cavity surface emitting laser, according to one arrangement.

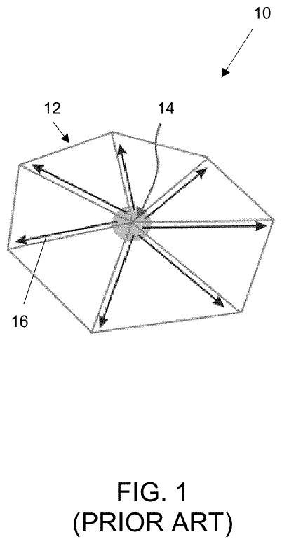

### DETAILED DESCRIPTION

Embodiments of the present innovation relate to a method and apparatus for modeling electromagnetic behavior using Hermite finite elements. In one arrangement, a modeling apparatus is configured to utilize Hermite finite element method function to represent an electromagnetic field of each element of an electronic component under development. With the use of Hermite finite element method function, the modeling apparatus can resolve issues arising with VFEM in both two- and three-dimensions. For example, with use of the Hermite finite element method function, the modeling apparatus can obtain high spatial resolution of the electromagnetic field while mitigating the effects of computational scaling and discretization errors. Further, use of the Hermite finite element method function improves the operation of the modeling apparatus relative to conventional computerized devices by reducing the amount of time necessary to generate a model of an electromagnetic field.

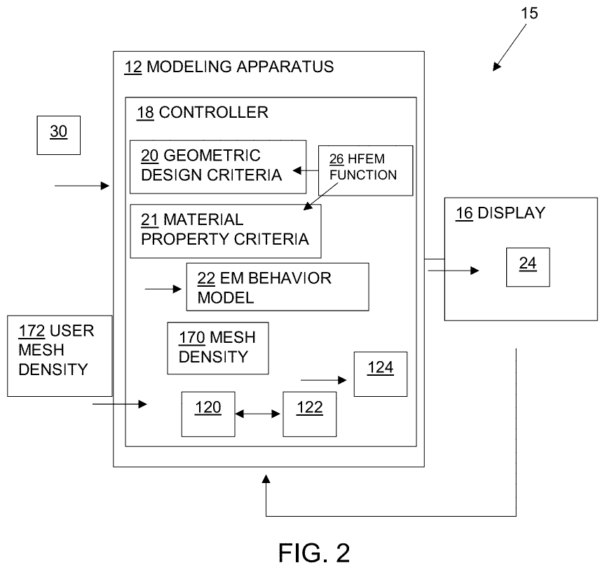

With reference to FIG. 2, a modeling system 15 can include a modeling apparatus 12 disposed in electrical communication with a display 16. For example, the modeling apparatus 12 can be configured as a computerized device having a controller 28, such as a memory and processor. The modeling apparatus 12 is configured to receive geometric design criteria 20 and material property criteria 21 for a wide variety of components 30, such as an electronic components, and to develop an electromagnetic behavior model 22 of the component 30 based on the criteria 20, 21. For example, the modeling apparatus 12 can be used in the modeling, development, and design of a variety of components 30, such as waveguides, vertical cavity surface emitting lasers (VCSEL), and photonic crystals, for example. In one arrangement, the computerized device 14 can provide the electromagnetic behavior model 22 to the display 16 as an image 24.

When developing the electromagnetic behavior model 22, the modeling apparatus 12 can be configured to apply a Hermite finite element method (HFEM) function 26 to the geometric design criteria 20 and material property criteria 21. Based upon such application, the modeling apparatus 12 is configured to mitigate the effects of spurious (i.e., invalid or nonphysical) solutions when developing the electromagnetic behavior of the model 22 of the component 30, as described below.

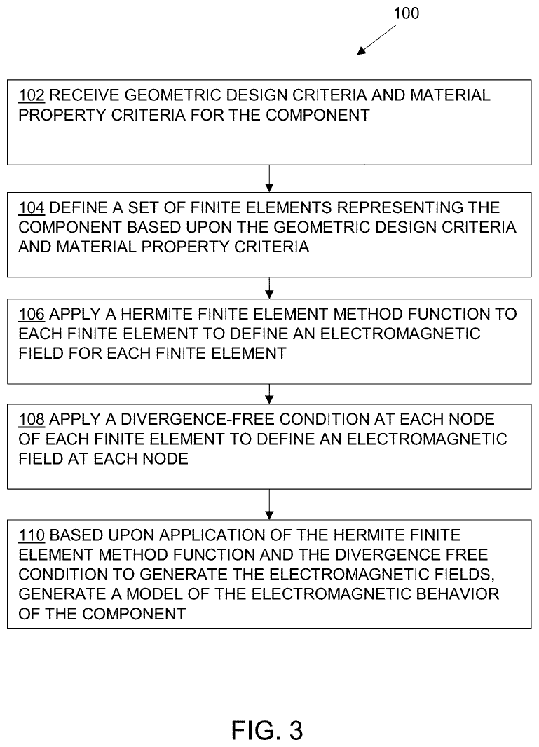

FIG. 3 illustrates a flowchart 100 showing an example operation of the modeling apparatus 12 of the modeling system 15 when identifying the electromagnetic behavior of a component 30. For example, for components such as antennae, optical fibers, and quantum well lasers in resonant cavities, designers typically need reliable and accurate electromagnetic field simulation or behavior in order to accurately design the components prior to manufacture. As will be described below, the modeling apparatus 12 is configured to generate the electromagnetic behavior model 22 for a particular component where the model 22 includes a relatively high degree of spatial resolution of the electromagnetic field with minimal effects of computational scaling and discretization errors.

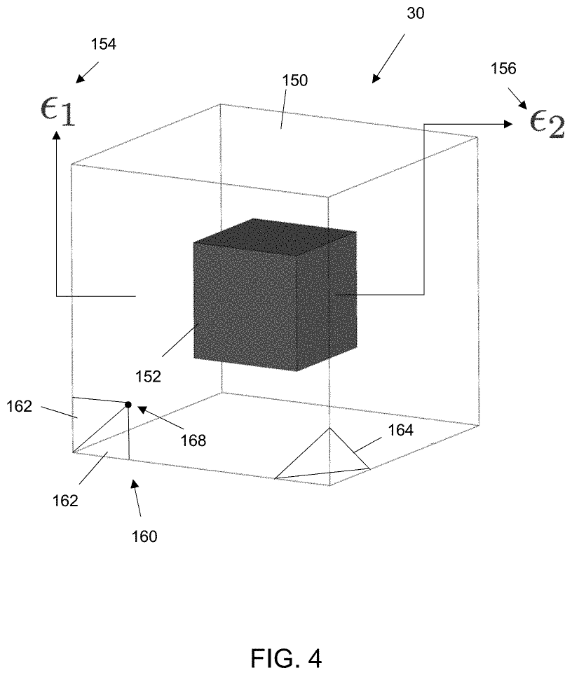

In element 102, the modeling apparatus 12 receives geometric design criteria 20 and material property criteria 21 for a component 30. In one arrangement, a designer can input the geometric design criteria 20 and material property criteria 21 to the modeling apparatus 12 in a variety of ways. For example, the designer can input the criteria 20, 21 for a component 30 via a graphical user interface (GUI) provided by the display 16. The geometric design criteria 20 and material property criteria 21 provide details regarding the component under design. For example, with reference to FIG. 4, the geometric design criteria 20 can define a cubic conducting cavity 150 having dimensions 1×1×1 mm³. Further, the modeling apparatus 12 can receive material property criteria 21 which indicates that the cavity 150 is loaded with a concentric cubic dielectric inclusion 152 of dimensions 0.5×0.5×0.5 mm³ and permittivity ϵ₂ 156. The material property criteria 21 can further indicate that permittivity in the rest of cavity 150 is ϵ₁ 154.

Returning to FIG. 2, in element 104, the modeling apparatus 12 defines a set of finite elements 160 representing the component 30 based upon the geometric design criteria 20 and material property criteria 21. In one arrangement, the modeling apparatus 12 can define the set of finite elements 160 as 2D finite elements 162 or 3D finite elements 164 where each finite element 160, 162 can include shared nodes 168 with adjoining finite elements 160.

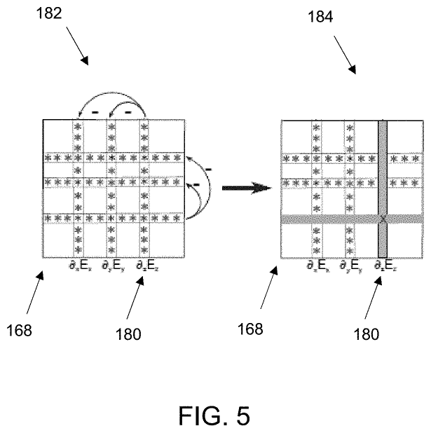

In one arrangement, the modeling apparatus 12 is configured to generate the finite elements 160, 162 according to a preconfigured finite element mesh density 170. For example, the modeling apparatus 12 can define the cubic conducting cavity of FIG. 5 with a mesh density 170 having 17576 degrees of freedom to accurately model the dielectric function of the component 30.

In one arrangement, the modeling apparatus 12 is configured to generate the finite elements 160, 162 according to a user-selected mesh density 172. With reference to FIG. 2, the modeling device 12 can receive the user-selected mesh density 172 based on a geometry of the component 30 to be modeled. For example, a designer can input the user-selected mesh density 172 via a graphical user interface (GUI) provided by the display 16. Upon receipt of the user-selected mesh density 172, the modeling apparatus can utilize the geometric design criteria 20, the material property criteria 21, and the user-selected mesh density 172 to define the set of finite elements 160, 162 to represent the component 30.

Returning to FIG. 2, in element 106, the modeling apparatus 12 applies a Hermite finite element method function 26 to each finite element 160, 162 to define an electromagnetic field for each finite element 160, 162.

Electromagnetic fields in a physical system should satisfy the wave equation (Eq. (1)) along with a divergence-free condition (Eq. (2)). For example, in the electric field formulation (E-field), Maxwell's equations of the form

∇×∇×E=ϵμω²E; (1)

∇·ϵE=0, (2)

can be solved where ω is the eigenfrequency and ϵ and μ are the permittivity and permeability of the material. Computationally, if the modeling apparatus 12 were to attempt to solve the wave equation Eq. (1), the obtained solutions may not satisfy the divergence-free condition of Eq. (2). Solutions with either zero frequency (ω=0) or with non-zero divergence (∇·ϵE≠0) that are obtained while solving Eq. (1) are known as the spurious (i.e., invalid or nonphysical) solutions. Such spurious solutions can corrupt the desired eigenspectrum.

In one arrangement, the modeling apparatus 12 is configured to solve Maxwell's equations for time-harmonic fields, so that the electric field E(r, t)=E(r)e^{-iwt}, and similarly for the magnetic field H. Maxwell's equations then reduce to the 3D wave equation:

∇×[μᵣ⁻¹∇×E]=k₀²ϵᵣE, (3)

where ϵᵣ is the relative permittivity tensor, and μᵣ is the relative permeability tensor. This differential equation can be converted into an action integral,

A/T=∫_{V}d|V[∇×E*·μᵣ⁻¹∇×E−k₀²E*·ϵᵣE].

Additionally, in order to impose Eq. (2) above, a penalty term can be introduced to the action integral in the Hermite finite element method function 26. As such, when applying the Hermite finite element method function 26, the modeling apparatus 12 is configured to use the principle of stationary action to solve the action integral, as follows:

A/T=∫_{V}dV[∇×E*·μᵣ⁻¹∇×E−k₀²E*·ϵᵣE+λ|∇·ϵᵣE|²],

where λ is the Lagrange multiplier. The penalty term, λ|∇·ϵᵣE|² is configured to set the divergence to zero.

The electromagnetic fields are represented by Hermite finite element method function 26 on 2D and/or 3D finite elements multiplied by the values of the fields and their derivatives at the vertices (nodes) of each element. The integral can be discretized over the elements to obtain a matrix equation in terms of the nodal parameters. The modeling apparatus 12 can be configured to utilize the principle of stationary action and can set the variation with respect to E* equal to zero. This yields a generalized eigenvalue problem which the modeling apparatus 12 solves to obtain the frequencies and field distributions of the resonating modes. The electromagnetic fields are readily obtained from the electric fields using Maxwell's equations. In one arrangement, application of a constant penalty term by the modeling apparatus 12 provides a computationally inexpensive method for mitigating a variety of zero-frequency spurious modes. For example, the modeling apparatus 12 can be configured to utilize a fixed Lagrange multiplier, λ=1.

As provided above, when using the penalty term, the modeling apparatus 12 can mitigate the presence of zero-frequency spurious modes within the electromagnetic behavior of the model 22 of the electrical component. However, one feature of the spurious modes is a relatively large divergence-to-curl ratio: |∇·E|/|∇×E|. As such, after determining the eigenfields, the modeling apparatus 12 can identify and remove any remaining spurious solutions based on this ratio. However, with application of only the penalty factor, the modeling apparatus 12 may not eliminate all the spurious solutions. As such, the spurious solutions can intermix with the acceptable physical solutions.

Returning to FIG. 3, in element 108, the modeling apparatus 12 applies a divergence-free condition at each node 168 of each finite element 160 to define an electromagnetic field at each node 168.

In one arrangement, to further mitigate the presence of spurious solutions, the modeling apparatus 12 is configured to impose a divergence-free condition (Eq. (2) provided above) at each node 168 of the matrix defining the geometry of the component 30 using the derivative degrees of freedom. For example, with reference to FIG. 5, following application of the Hermite finite element method function 26, the modeling apparatus 12 is configured to impose the divergence-free condition on a node 168 by performing global matrix row and column operations. As such, the modeling apparatus 12 eliminates one of the terms in the zero-divergence condition, equation ∇·ϵᵣ E, in favor of the other two.

For example, the procedure is shown in FIG. 5 for the case of a constant ϵᵣ. As illustrated, for the term ∂_{z}E_{z} 180 of matrix 182, X is initially set equal to 1. With the application of the divergence-free condition, X is set to a relatively large value in the right-hand side matrix, as indicated in matrix 184 in the generalized eigenvalue problem. This selection of a relatively large number pushes the eigenvalue of the redundant 1×1 subspace out of the spectral range of interest. Applying this technique drives the divergence-to-curl ratio of physically admissible solutions even lower, and that of spurious solutions higher. As such, the modeling apparatus 12 enhances the ratio |∇·E|/|∇×E| for spurious solutions and reduces this ratio for physical solutions. In one arrangement, in the case where second derivative degrees of freedom are available, such as in quantic elements, this ratio can be further enhanced by imposing an additional divergence-free condition using second derivative degrees of freedom. Further, this procedure can be extended in the case where higher degrees of freedom are present as well.

By providing a node-based HFEM representation, the modeling apparatus provides consistency in the direction of fields at the vertices of elements and, hence, is well suited to model transport problems such as electron microscope design and particle accelerators where the particles are driven by microwave fields. Accordingly, the modeling apparatus 12 can provide multiscale calculations with minimal computational costs, which is not feasible with conventional VFEM due to the lack of unique directionality for fields at shared nodes in the finite element mesh.

Since the modeling apparatus 12 applies the divergence condition at each node 168, the total divergence of the physically admissible solutions for an electromagnetic behavior of the model 22 of the component decreases further with mesh refinement, whereas the divergence increases considerably for spurious solutions. This is manifested as the element size is reduced, and the interpolation from the nodes 168 having the divergence-free condition into the interior of the elements is more effective, with increasing mesh density. This is in contrast to conventional VFEM applications, where the normal discontinuity of edge elements leads to the formation of artificial charges at element interfaces, thus increasing the total divergence of the solutions. In conventional VFEM applications, this phenomenon worsens with mesh refinement. Further in conventional VFEM, the zero-frequency spurious solutions are separated by filtering out the null-space of the curl operator from the spectrum using iterative techniques or by finding eigenvalues in the interior of the spectrum. This is necessary, since if the physical solution space is not normal to the null space, the physical solutions will be polluted by null vectors.

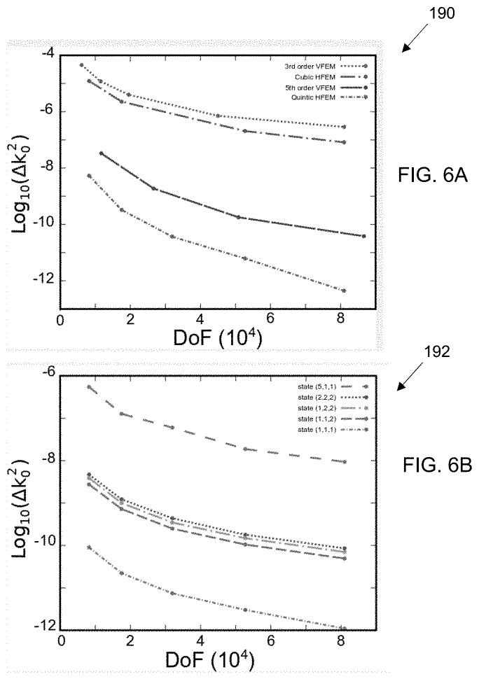

By mitigating the zero-frequency spurious modes as described above, the modeling apparatus 12 is configured to reduce convergence errors in the eigenvalues of the modeled electromagnetic field of a component 30, such as an electronic component, as compared to conventional VFEM approaches. For example, FIG. 6A is a graph 190 illustrating the convergence of errors in eigenvalues of the first mode for the 3rd order VFEM, 5th order VFEM, cubic Hermite, and quintic Hermite finite element method functions 26. As shown, development of a modeled electromagnetic field by application of the HFEM function 26 to given geometric design criteria 20 having particular material property criteria 21 generates a convergence of eigenvalues having less error than converged eigenvalues generated using VFEM. Further, FIG. 6B is a graph 192 illustrating higher frequency modes for HFEM only for the case of an empty cubic cavity of unit dimensions. By using the Hermite finite element method function 26, the modeling apparatus 12 can reduce the error in the first mode up to 10⁻⁹ with just 27 elements and 8232 DoF, with further reduction in error possible with mesh refinement. The total DoF corresponds to the global matrix dimension.

Returning to FIG. 3, in element 110, based upon application of the Hermite finite element method function 26 and the divergence free condition to generate the electromagnetic fields, the modeling apparatus 12 generates a model 22 of the electromagnetic behavior of the component 30. In one arrangement, the modeling apparatus 12 can provide the electromagnetic behavior model 22, as well as the working characteristics of the component 30, to the display 16 as an image 24. Based upon the model 22, the designer can review the electromagnetic behavior of the component 30 under design and can change design parameters of the component 30, if needed, to adjust its electromagnetic field.

For example, with reference to FIG. 2, assume the case where the model 22 of the component 30, such as provided as image 24 to the display 16, indicates that the electromagnetic behavior is inappropriate for a particular application. With such an indication, the designer can provide feedback to the modeling apparatus 12 in order to receive a more appropriate model 22. For example, the designer at least one of an updated geometric design criteria 20, an updated material property criteria 21, and an updated user-selected mesh density 172 to the modeling apparatus 12 in an attempt to adjust the resulting electromagnetic behavior model 22. In one arrangement, the feedback can be provided through a GUI displayed by display 16. Following receipt, the modeling apparatus 12 is configured to repeat the process of defining a set of finite elements to represent the component 30, applying the Hermite finite element method function 26 to each finite element to define an electromagnetic field for each finite element, and applying a divergence-free condition at each node 168 of each finite element to define an electromagnetic field at each node 168. The modeling apparatus 12 can then output the resulting, updated model 22 of the electromagnetic behavior of the component 30 for further review by the designer.

As provided above, the modeling apparatus 12 is configured to provide electromagnetic simulations with Hermite finite elements and can deliver relatively high accuracy and smoother representation of electromagnetic fields relative to conventional VFEM techniques. For example, when utilizing VFEM the divergence free constraint for the electromagnetic fields results in spurious solutions for the wave equation and their eigenfrequencies are pushed to zero, either through Nedelec compliance or through their removal at each iteration. In either case, this is an expensive numerical procedure. By contrast, when utilizing HFEM function 26, the modeling apparatus 12 is configured to impose a divergence-free condition by adding a constant penalty term (with a Lagrange multiplier, set to unity). In addition, through the derivative degrees of freedom at each node, the modeling apparatus 12 imposes the same constraint explicitly to mitigate the non-zero frequency spurious solutions by identifying them through their large |∇·E|/|∇×E| ratio. This procedure does not alter or influence the accuracy of the physical solutions.

As provided in the example above, the modeling apparatus 12 was configured to develop an electromagnetic field model for a metallic cubic cavity. It should be understood that the modeling apparatus 12 can be configured to model electromagnetic fields for a variety of devices and composite structures, such as 3D photonic band-gap crystals, radio-frequency cavities, and metamaterials and topological photonic systems, for applications in ultra-small optical integrated circuits. Also, when executing the HFEM function 26, the modeling apparatus 12 can simulate electrodyamics, plasmonics, high frequency circuitry, and mixed physics problems.

Further, when executing the HFEM function 26, the modeling apparatus 12 links nanoscale and macroscale since FEM is based on nodes 168. Accordingly, the modeling apparatus 12 is configured to provide multiscale analysis. This option is not open to VFEM due to the lack of directionality for fields at shared nodes in the finite element mesh. Very dense meshes lead to larger regions in which field directions are ill-defined. By contrast, the scalar Hermite polynomials have several fundamental advantages for obtaining the band structure of periodic systems such as photonic crystals, compared with VFEM and other plane wave expansion methods. Further, when executing the HFEM function 26, the modeling apparatus 12 requires substantially less computational costs, compared to computers executing conventional techniques such as VFEM. Additionally, the modeling apparatus 12 can capture spatial complexity in the dielectric distributions, a substantially higher numerical convergence with scaling, and can obtain variational eigenfunctions free of numerical artifacts.

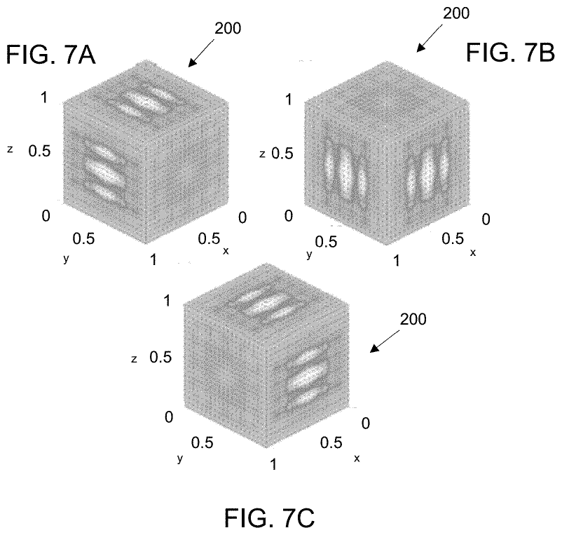

In one arrangement, the modeling apparatus 12 is configured to identify the surface currents on an electronic device. These currents ensure that the magnetic field outside the device is identically zero and can appear in singlets, doublets and triplets. For example, the modeling apparatus 12 can provide surface currents of the triply degenerate modes, as illustrated in FIG. 7A (0, 1, 1), in FIG. 7B (1, 0, 1), and in FIG. 7C (1, 1, 0), of a dielectrically loaded cavity 200 with eigenvalue k₂₀=18.5267. The cubic dielectric has dimensions 0.5×0.5×0.5 mm³, with a dielectric constant ϵ₂/ϵ₁=1.2.

As provided above, spurious solutions at the nodes 168 can intermix with acceptable physical solutions. In one arrangement, with reference to FIG. 2, the modeling apparatus 12 is configured to utilize a spurious solution threshold 220 to identify the presence of such spurious or nonphysical solutions. For example, for each node 168 of each finite element of a modeled component 30, the modeling apparatus is configured to detect a divergence-to-curl ratio 222, such as provided by |∇·E|/|∇×E|. As provided above, one feature of a spurious modes is a relatively large divergence-to-curl ratio. Accordingly, in one arrangement, by comparing the divergence-to-curl ratio 222 to a relatively low-value spurious solution threshold 220, the modeling device 12 can identify the presence of a spurious solution at a particular node 168 when the divergence-to-curl ratio 222 exceeds the spurious solution threshold 220.

In the case where the modeling apparatus 12 detects the divergence-to-curl ratio 222 as exceeding the spurious solution threshold 220 for a node 168, the modeling apparatus 12 can identify the defined electromagnetic field at that node 168 as being a spurious solution 224. As a result, to minimize the presence of spurious solutions in a given electromagnetic behavior model 22 of a component 30, the modeling apparatus 12 can be configured to increase the mesh density 170 of the set of finite elements representing the component 30. For example, as provided above, the interpolation from the nodes 168 having the divergence-free condition into the interior of the elements is more effective with increasing mesh density. As such, by increasing the mesh density 170 and repeating the process provided in elements 104-110 of FIG. 3, the modeling apparatus 12 can decrease the presence of spurious solutions at particular nodes 168.

As indicated above, the modeling apparatus 12 is configured to generate an electromagnetic behavior model 22 of a component 30 based upon geometric design criteria 20, material property criteria 21, and mesh density information 170. As such, the modeling apparatus 12 can generate models 22 for a variety of components 30, including multi-scale, and/or multi-physics components 30, such as vertical cavity surface emitting lasers (VCSEL).

As provided above, in vector finite elements, field directions are ill-defined at each node. Hence, vector finite elements are unsuitable to determine the particle trajectories while designing electron microscopes, vacuum tubes, and in high energy accelerators. Vector elements are also ineffective in modeling multi-scale, and/or multi-physics problems. Such problems require self-consistent solutions from both quantum mechanical/acoustic and electromagnetic calculations. Quantum mechanical or acoustic calculations involve scalar equations, and cannot be treated using vector elements. In such instances, independent numerical treatments have been used to obtain the wave functions and EM fields.

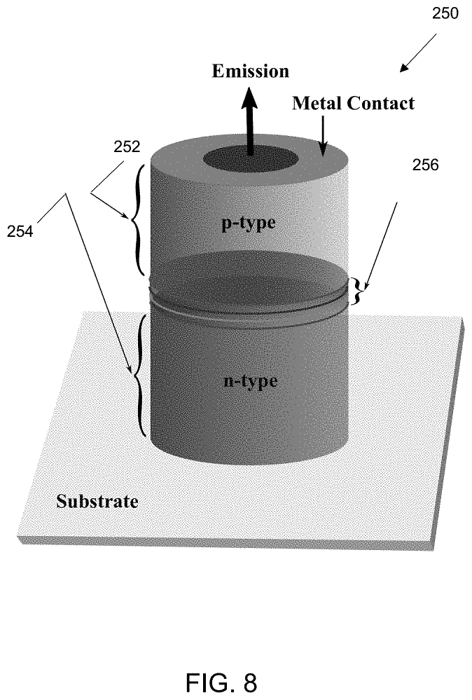

FIG. 8 illustrates a schematic diagram of a vertical cavity surface emitting laser (VCSEL) component 250. The VCSEL component 250 can be considered a multi-physics component. For example, the component 250 includes a first electromagnetic cavity portion 252 (e.g., p-type) and a second electromagnetic cavity portion 254 (n-type), as well as a quantum well 256. Further, the VCSEL component 250 can be considered a multi-scale component. For example, the first and second electromagnetic cavity portion 252, 254 are provided on the micrometer scale, while the quantum well 256 is provided on the nanometer scale. The modeling apparatus 12 can apply the Hermite finite element method function 26 to the geometric design criteria 20 and material property criteria 21 of the component 250 to generate an electromagnetic behavior model 22 as the HFEM function 26 has well-defined field directions and provides accurate solutions across length scales in such systems for both the electron wave functions in the quantum well region 256 and the EM fields inside and outside the quantum well 256.

While various embodiments of the innovation have been particularly shown and described, it will be understood by those skilled in the art that various changes in form and details may be made therein without departing from the spirit and scope of the innovation as defined by the appended claims.

What is claimed is:

1. In a modeling apparatus, a method of identifying electromagnetic behavior of a component, comprising:
receiving, by the modeling apparatus, geometric design criteria and material property criteria for the component;
defining, by the modeling apparatus, a set of finite elements representing the component based upon the geometric design criteria and material property criteria;
applying, by the modeling apparatus, a Hermite finite element method function to each finite element to define an electromagnetic field for each finite element;
applying, by the modeling apparatus, a divergence-free condition at each node of each finite element to define an electromagnetic field at each node; and
based upon application of the Hermite finite element method function and the divergence free condition to generate the electromagnetic fields, generating, by the modeling apparatus, a model of the electromagnetic behavior of the component.

2. The method of claim 1, wherein defining the set of finite elements representing the component further comprises defining, by the modeling apparatus, the set of finite elements as at least one of 2D finite elements and 3D finite elements.

3. The method of claim 1 further comprising:
receiving, by the modeling apparatus, a user-selected mesh density based on a geometry of the component; and
defining the set of finite elements representing the component comprises defining, by the modeling apparatus, the set of finite elements representing the component based upon the geometric design criteria, the material property criteria, and the user-selected mesh density.

4. The method of claim 1, wherein when applying the Hermite finite element method function, comprises using, by the modeling apparatus, the principle of stationary action, to solve the following action integral:
A/T=∫_{V}dV[∇×E*·μᵣ⁻¹∇×E−k₀²E*·ϵᵣE+λ|∇·ϵᵣE|²]
where E is an electric field, ϵᵣ is a relative permittivity tensor, μᵣ is a relative permeability tensor, and λ is a Lagrange multiplier.

5. The method of claim 1, wherein the divergence-free condition at each node satisfies the following relation:
∇·ϵE=0
where E is an electric field and ϵ is a permittivity tensor.

6. The method of claim 1, wherein generating the model of the electromagnetic behavior and working characteristics of the component comprises generating, by the modeling apparatus, a multi-physics model of the electromagnetic behavior and working characteristics of the component.

7. The method of claim 1, wherein generating the model of the electromagnetic behavior and working characteristics of the component comprises generating, by the modeling apparatus, a multi-scale model of the electromagnetic behavior and working characteristics of the component.

8. The method of claim 1, further comprising:
for each node of each finite element, detecting, by the modeling apparatus, a divergence-to-curl ratio, |∇·E|/|∇×E|;
comparing, by the modeling apparatus, the divergence-to-curl ratio to a spurious solution threshold; and
when the divergence-to-curl ratio exceeds the spurious solution threshold for a node, identifying, by the modeling apparatus, the defined electromagnetic field at that node as a spurious solution.

9. The method of claim 8, wherein, in response to identifying the defined electromagnetic field at that node as a spurious solution:
increasing, by the modeling apparatus, a mesh density of the set of finite elements representing the component; and
repeating, by the modeling apparatus:
applying the Hermite finite element method function to each finite element to define an electromagnetic field for each finite element,
applying the divergence-free condition at each node of each finite element to define an electromagnetic field at each node,
generating a model of the electromagnetic behavior of the component based upon application of the Hermite finite element method function and the divergence free condition, and
for each node of each finite element, detecting a divergence-to-curl ratio.

10. The method of claim 9, further comprising, receiving, by the modeling apparatus, at least one of updated geometric design criteria and updated material property criteria for the component based upon the model of the electromagnetic behavior of the component.

11. A modeling apparatus, comprising:
a controller having a processor and a memory, the controller configured to:
receive geometric design criteria and material property criteria for the component;
define a set of finite elements representing the component based upon the geometric design criteria and material property criteria;
apply a Hermite finite element method function to each finite element to define an electromagnetic field for each finite element;
apply a divergence-free condition at each node of each finite element to define an electromagnetic field at each node; and
based upon application of the Hermite finite element method function and the divergence free condition to generate the electromagnetic fields, generate a model of the electromagnetic behavior of the component.

12. The modeling apparatus of claim 11, wherein when defining the set of finite elements representing the component, the controller is configured to define the set of finite elements as at least one of 2D finite elements and 3D finite elements.

13. The modeling apparatus of claim 11, wherein the controller is further configured to:
receive a user-selected mesh density based on a geometry of the component; and
when defining the set of finite elements representing the component, define the set of finite elements representing the component based upon the geometric design criteria, the material property criteria, and the user-selected mesh density.

14. The modeling apparatus of claim 11, wherein when applying the Hermite finite element method function, the controller is configured to use the principle of stationary action to solve the following action integral:
A/T=∫_{V}dV[∇×E*·μᵣ⁻¹∇×E−k₀²E*·ϵᵣE+λ|∇·ϵᵣE|²]
where E is an electric field, ϵᵣ is a relative permittivity tensor, μᵣ is a relative permeability tensor, and λ is a Lagrange multiplier.

15. The modeling apparatus of claim 11, wherein the divergence-free condition at each node satisfies the following relation:
∇·ϵE=0
where E is an electric field and ϵ is a permittivity tensor.

16. The modeling apparatus of claim 11, wherein when generating the model of the electromagnetic behavior and working characteristics of the component, the controller is configured to generate a multi-physics model of the electromagnetic behavior and working characteristics of the component.

17. The modeling apparatus of claim 11, wherein when generating the model of the electromagnetic behavior and working characteristics of the component, the controller is configured to generate a multi-scale model of the electromagnetic behavior and working characteristics of the component.

18. The modeling apparatus of claim 11, wherein the controller is further configured to:
for each node of each finite element, detect a divergence-to-curl ratio, |∇·E|/|∇×E|;
compare the divergence-to-curl ratio to a spurious solution threshold; and
when the divergence-to-curl ratio exceeds the spurious solution threshold for a node, identify the defined electromagnetic field at that node as a spurious solution.

19. The modeling apparatus of claim 18, wherein, in response to identifying the defined electromagnetic field at that node as a spurious solution, the controller is configured to:
increase a mesh density of the set of finite elements representing the component; and
repeat applying the Hermite finite element method function to each finite element to define an electromagnetic field for each finite element, applying the divergence-free condition at each node of each finite element to define an electromagnetic field at each node, generating a model of the electromagnetic behavior of the component based upon application of the Hermite finite element method function and the divergence free condition, and for each node of each finite element, detecting a divergence-to-curl ratio.

20. The modeling apparatus of claim 19, wherein the controller is further configured to receive at least one of updated geometric design criteria and updated material property criteria for the component based upon the model of the electromagnetic behavior of the component.
